(19) United States
(12) Patent Application Publication
(10) Pub. No.: US 2008/0032046 A1
(43) Pub. Date: Feb. 7, 2008

(54) Process for applying protective coatings to railroad crossties, telephone poles and telephone pole crossties

(76) Inventors: Alan R. Sporn, Laguna Hills, CA (US); Gabriel Pilon, Fountain Valley, CA (US)

Correspondence Address: ST. GEORGE & CARNEGIE, 5405 ALTON PARKWAY, SUITE 5A, PMB 540, IRVINE, CA, 92604, US

(21) Appl. No.: 11/888,499

(22) Filed: Jul. 31, 2007

Related U.S. Application Data
(60) Provisional application No. 60/835,306, filed on Aug. 3, 2006.

(51) Int. Cl. B05D 3/12

(52) U.S. Cl. 427/299

(57) ABSTRACT

A process of applying a protective coating to railroad crossties, telephone poles, and telephone pole crossties is provided. The protective coating includes a polymer or polyurea resin that is sprayed, brushed, or rolled onto the railroad crossties, telephone poles, and telephone pole crossties. Alternatively, the railroad crossties, telephone poles, and telephone pole crossties may be immersed in a tank containing the protective coating. A strengthening material including aramid fiber fabric may be disposed adjacent the railroad crossties, telephone poles, and telephone pole crossties or between layers of the applied protective coating to provide increased tensile strength thereto.

### CROSS REFERENCE TO RELATED APPLICATIONS

The present application claims priority from provisional patent application Ser. No. 60/835,306 filed on Aug. 3, 2006, entitled “Protective Coatings for Railroad Crossties, Telephone Poles and Telephone Pole Crossties”, the entire disclosure of which is herein incorporated by reference.

### FIELD OF THE INVENTION

The present invention relates generally to protective coating processes and more particularly to application techniques for applying a coating or multiple coatings of a polymer or polyurea resin to railroad crossties, telephone poles and telephone pole crossties to extend the useful life thereof through an encapsulating process.

### BACKGROUND OF THE INVENTION

Conventionally treated wooden crossties for use as railroad crossties and with telephone poles eventually rot and must be disposed of and replaced. It is estimated that the average life of a wooden railroad crosstie is only fifteen years. Concrete railroad crossties, a more recent innovation, have a history of breaking. Rotted and broken crossties can lead to train derailments and downed power lines.

The current treatment used on wood crossties can be creosote, an oily liquid preservative, chromated copper arsenic, and other chemicals. Rain, snow, sun and other weather elements have a direct impact on crossties that cause the hazardous chemicals to migrate into the surrounding soil, producing a harmful environmental effect.

The sun has an evaporative effect on the chemically treated crossties. As this evaporation of the chemical preservatives continues, the cellulose wood fibers become exposed, and this leads to continual degradation of the crossties.

When the crossties are taken out of service due to degradation, rot and/or disintegration, the disposal of treated wood crossties causes another costly environmental problem. Many state Environmental Protection Agencies do not allow creosoted wooden crossties to be burned or incinerated because of the emission of toxic fumes.

Because wooden crossties have a very limited useful lifespan, they must be replaced regularly. New wooden crossties must be purchased and treated, transported to the railroad beds and/or power lines. They then must be installed using complex machinery and much skilled labor. During this process, the affected rail lines and/or power lines need to be shut down, some times for days. The expense to the industries, in terms of materials, labor, disposal costs and disruption of service, is very high.

Wood has traditionally been, and will probably continue to be, the predominant material for railroad track crossties. Wood has several advantages over alternative crosstie materials, such as concrete and even composite materials. Wood is a renewable natural resource and is available in many parts of the world at reasonable costs. Another important advantage of wood is its natural resiliency, which enables wooden railroad crossties to absorb the dynamic loads that are associated with railroad traffic. Wooden railroad crossties tend to be lighter than comparable concrete railroad crossties, and therefore can be relatively easily handled by installation and maintenance crews and equipment.

A significant disadvantage of wooden railroad crossties is that they are susceptible to deterioration and decay. Since wood is a cellulose material, it is subject to damage from fungus, decay, termite infestation, the stress and strain of railroad usage and exposure to the elements in unprotected outdoor environments. Railroad crossties are particularly susceptible to damage and deterioration in the railroad crosstie ends and in the connection areas adjacent to each end where the tracks are attached to the railroad crossties. The typical construction of railroad track involves the placement of railroad crossties about eighteen to thirty inches apart on a roadbed of ballast comprising crushed rock or the like.

Although preservatives are commonly applied to structural wooden members that will be exposed to the natural elements, the protection provided by such preservatives tends to lessen over time because the preservatives are susceptible to the deteriorating effects of sunlight, precipitation, freeze-thaw cycles, and so forth. Thus, the useful service life of a railroad crosstie is generally limited.

There have been numerous attempts made to develop a substitute process for fabricating crossties. These attempts include crossties made from steel, concrete, and thin particleboard sheets made from recycled wood crossties or other materials and laminated together. These attempts have not been successful in replacing wooden crossties on a large scale, due to several factors including higher cost, lack of sufficient strength and durability to withstand the cyclical bending loads peculiar to crossties, and non-adaptability of some materials to spikes or screws for fastening rails to new style crossties.

Furthermore, it has been difficult to obtain desired physical properties in the finished products. In order to make a product that can be used as a substitute for a finished wood product made of lumber, the product must have a relatively high tensile strength. Lumber has a high tensile strength along the grain of the wood because of the orientation of the wood fibers. However, in manufacturing wood/polymer composite replacement products, the size of the wood particles has been very limited, so that the products made of these replacement materials have not been able to achieve comparable tensile strength. As a result, many of these products have been relatively brittle and inferior to those made of lumber.

When railcars travel over railroad track, they are often subjected to an undesirable amount of vibration and periodic impacts that tend to dislodge cargo, damage railroad crossties and railcar structures, degrade railroad track, and/or annoy passengers. Accordingly, much effort has been expended to design railroad tracks in a way that minimizes these vibrations and impacts.

Railroad track typically include two parallel metal rails mounted on a plurality of transverse railroad crossties. The crossties, in turn, are usually supported by ballast that typically comprises rock or other similar material and is laid over subgrade or other type of underlayment. In the case of “open track”, the subgrade is simply the ground, while in the case of track laid over a bridge, tunnel, or other structure; the subgrade may be concrete, wood, or another such material. In addition, it is often desirable to include an impermeable layer of sub ballast between the ballast and the subgrade, typically comprising compacted fine gravel.

Excessive rail car vibration can result from too little track deflection as a railcar moves over the track. Though metal rails and concrete crossties will deflect somewhat under the weight of a passing rail car, the amount of deflection each contributes to the total track deflection needed for a smooth ride is relatively insignificant. The ballast provides most of the deflection provided to the railroad track components. Open ground can also contribute a relatively significant amount of deflection under the weight of a passing rail car. The amount of open ground deflection varies significantly depending upon the type of terrain.

The total deflection of track laid over open ground is usually sufficient to provide an adequately smooth ride. In instances where this is not the case, such as where the ground is particularly rocky, additional ballast may be provided, or wood crossties may be used, which deflect more than concrete crossties or composite wood.

One problem encountered with these solutions is that, even where the deflection of the track on a structure such as a tunnel or a bridge is sufficient to dampen vibrations, a rail car traveling over a bridge or tunnel may nonetheless receive a significant transition impact or shock. This transition impact results not from the steady vibrations caused by insufficient cushioning over the length of the bridge or tunnel, but instead from the boundary between the bridge, tunnel, or other structure and its adjacent approach. Further, the resulting transition impact may be transmitted along the length of a train when each rail car in the train passes over the boundary. An additional problem with existing solutions to reduce rail car vibrations in tunnels is that the soft material used for cushioning wears significantly after repeated deflections, either hardening to the point where vibration once again becomes a problem, or failing altogether.

What is needed therefore is a system for reducing vibrations and periodic impacts encountered as a railroad car travels over transitions between open track and structures such as bridges or tunnels. Furthermore, a need exists for improved processes for coating and strengthening all types of crossties and telephone poles that solves the problems of frequent replacement and inherent polluting disposal issues, both at the new procurement stage and at any other stage to extend the useful life of the coated crosstie for many years. There is also a need for a coating process that increases the tensile strength of crossties and reduces the flexion thereof. There is a further need for a coating process that provides waterproof, sun proof, and weatherproof qualities to crossties and telephone poles while providing strength thereto. There is also a need for an inexpensive coating process that prolongs the useful life of crossties and telephone poles.

### SUMMARY OF THE INVENTION

The present invention provides for application techniques for applying a polymer or polyurea coating to new and used railroad crossties, telephone poles, and crossties of any type of material makeup such a wood, concrete and composite materials. The application techniques provide longevity of the target object as well as providing added strength.

In one aspect of the invention, the inventive process includes applying a polymer coating or multiple polymer coatings to railroad crossties, telephone poles or telephone pole crossties. The railroad crossties, telephone poles and telephone pole crossties may be of any material including wood, concrete, and composite material.

In accordance with another aspect of the invention, a strengthening, dampening, or cushioning layer of fiber, fabric, wire, or composite mesh is applied before the coating process.

In accordance with another aspect of the invention, a strengthening, dampening or cushioning layer of fiber, fabric, wire, or composite mesh is applied during the coating process.

In accordance with yet another aspect of the invention, a process for applying a protective coating to a target object including railroad crossties, telephone poles, and telephone crossties includes preparing the target object, and applying a protective coating of a polymer resin to the target object.

In accordance with another aspect of the invention, a process for applying a protective coating to a target object including railroad crossties, telephone poles, and telephone crossties includes preparing the target object, applying a first protective coating of a polymer resin to the target object, wrapping the target object with a fabric, and applying a second protective coating of a polymer resin to the wrapped target object.

In accordance with another aspect of the invention, a process for applying a protective coating to a target object including railroad crossties, telephone poles, and telephone crossties includes preparing the target object for application of the protective coating, applying a first adhesive coating of a polymer resin to the target object, wrapping the target object with an aramid fiber fabric, and applying a second protective coating of polyurea to the wrapped target object.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one exemplary embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a cross sectional view of an exemplary crosstie having an applied coating material in accordance with the invention;

FIG. 2 is a cross sectional view of an exemplary crosstie having a strengthening material encapsulated by an applied coating material in accordance with the invention;

FIG. 3 is a cross sectional view of an exemplary crosstie having a strengthening material encapsulated between layers of applied coating materials in accordance with the invention;

FIG. 4 is a flow diagram of a process for applying a protective coating to a crosstie in accordance with the invention;

FIG. 5 is a flow diagram of an alternative process for applying a protective coating to a crosstie in accordance with the invention; and

FIG. 6 is a flow diagram of another alternative process for applying a protective coating to a crosstie in accordance with the invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

The present invention relates to a process of applying a protective coating to railroad crossties, telephone poles, and telephone pole crossties (target objects). In a preferred embodiment, the coating material is a polymer or polyurea resin that is sprayed onto the target object. In an alternative embodiment, the coating material is brushed onto the target object. In another alternative embodiment, the coating material is rolled onto the target object. In yet another alternative embodiment, the target object is immersed in the coating material. In some embodiments, providing a layer or multiple layers of a strengthening material including aramid fiber enhances the strength of the target object.

A preferred coating material includes a polyurea comprising equal parts of an amine-terminated resin and isocyanate. The polyurea is preferably sprayed on the target object in the form of a liquid precursor that crosslinks under ambient conditions to form a solid layer that adheres strongly to the target object. A preferred sprayable formulation of the polyurea has been found to have the following typical properties/characteristics:

| | Component “A” | Component “B” |
|---|---|---|
| Physical Properties of Components | (ISO) | (RESIN) |
| Viscosity at 75° F. | 950-1500 cps | 350-600 cps |
| Specific Gravity (gr/ml) | 1.10-1.12 (gr/ml) | 1.02-1.05 (gr/ml |

Physical Properties

| | |
|---|---|
| Density (pcf) ASTM D-1622 | 70 |
| Hardness (Shore D) ASTM D-2240 | 55 |
| Abrasion resistance (taber) | n/a |
| Tensile strength (psi) ASTM D-412 | 2300 |
| Elongation (%) ASTM D-412 | 150 |
| Tear resistance (pli) ASTM D-624 | 480 |
| Die, C | |

Handling Characteristics

| Mix Ratio by Weight (Component A/Component B) | 1:1 | |
|---|---|---|
| Mix Ratio by Volume (Component A/Component B) | 49:51 | |
| Gel Time (at 130 to 150° F.), (seconds) | 3 | sec. |
| Tack Free Time (seconds) | 15 | sec. |
| Demold Time (minutes) | 20 | min. |
| Final Cure time (hours) | 24 | hours |

In embodiments where the polyurea is applied using a brush or roller, the components of the polyurea are premixed in a container and applied to the target object using the brush or roller. In embodiments where the target object is immersed in the coating material, the components of the polyurea are premixed in a tank. In these embodiments, a formulation is used that gels somewhat slower than the formulation used for spray applications.

In embodiments where a strengthening material is applied to the target object, the material may include a textile such as woven cloth or a knit fabric woven or knit from yarns of a fibrous material such as fiberglass, carbon, or aramid. Other types of fiber, including nylon, polyester, natural fibers such as cotton, wool, linen, or silk, or synthetic forms of natural fibers, such as synthetic spider silk, may also be used. More than one type of fiber may be combined within yarns or cloth.

It should be noted that fiber type and weave density are chosen to achieve the desired combination of elongation, stiffness, tensile strength, and cost. The orientation of yarns also affects the properties of woven cloth. Yarns may intersect each other at angles of 90°, 45°, or other angles. For example, cloth may be woven with vertical yarns of nylon fiber, horizontal yarns of glass fiber, and with yarns of cotton passing diagonally through cloth. The piece of strengthening material may be precut before application of the coating material. The number of layers (or thickness) required depends on the application. Prefabricated and/or laminated weave in the thickness desired may be used, or one or more layers of the strengthening material may be wrapped around the target object. Wrapping allows for a combination of yarn intersections.

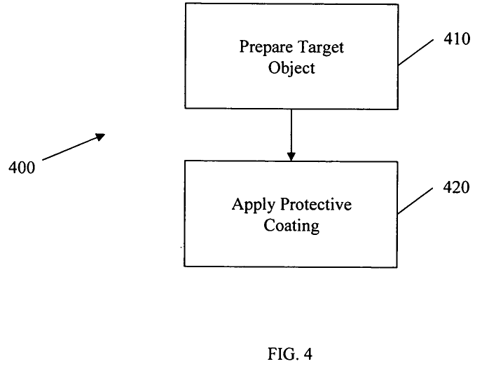

With reference to FIG. 4, a process of applying a protective coating to a railroad crosstie, a telephone pole, or a telephone crosstie generally designated 400 includes two steps. In a first step 410, the target object is prepared to receive the coating material. Preparation may include cleaning, sanding, and scoring of the surface of the target object. In a second step 420, the protective coating is applied to the target object. Application methods include spraying, brushing, rolling and immersion.

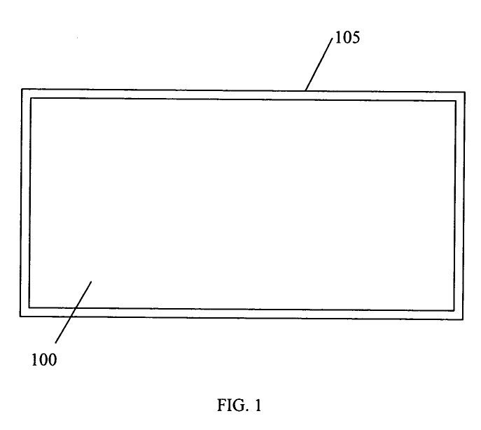

As shown in FIG. 1, a cross tie 100 encapsulated in accordance with the process 400 of the invention includes a protective coating 105 therearound.

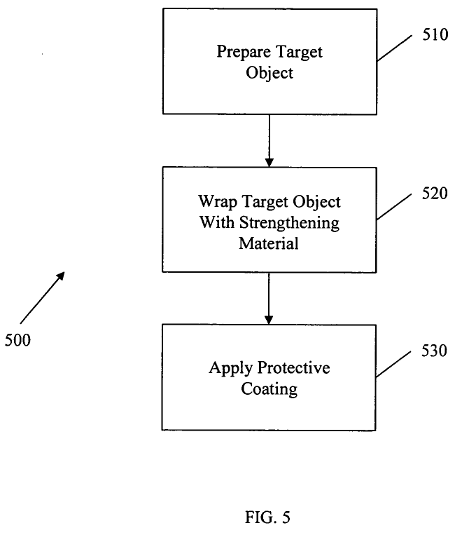

A first variant of the process of applying a protective coating to a railroad crosstie, a telephone pole, or a telephone crosstie generally designated 500 is shown in FIG. 5. In a step 510, the target object is prepared to receive the coating material. Preparation may include cleaning, sanding, and scoring of the surface of the target object. In a step 520, the target object is wrapped with a strengthening material. Alternatively, a precut strengthening material is applied to the target object. A protective coating is then applied to the target object in a step 530. Application methods include spraying, brushing, rolling and immersion.

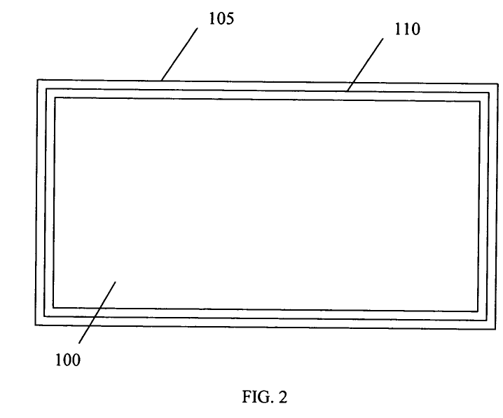

As shown in FIG. 2, a cross tie 100 encapsulated in accordance with the process 500 of the invention includes a strengthening material 110 surrounding the cross tie 100 and a protective coating 105 therearound.

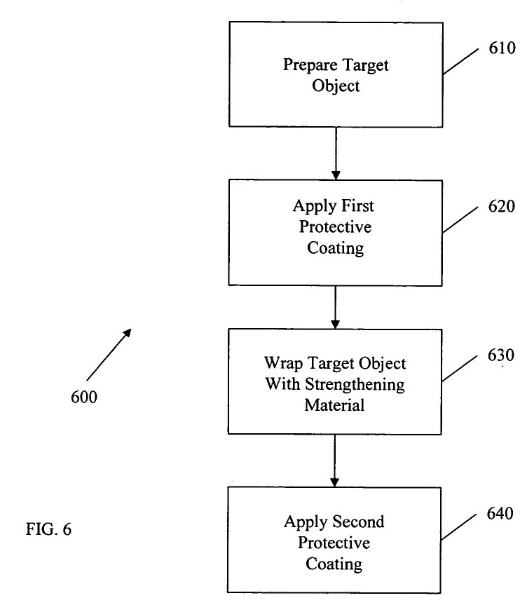

A second variant of the process of applying a protective coating to a railroad crosstie, a telephone pole, or a telephone crosstie generally designated 600 is shown in FIG. 6. In a step 610, the target object is prepared to receive the coating material. Preparation may include cleaning, sanding, and scoring of the surface of the target object. In a step 620 a first protective coating is applied to the target object. The first protective coating may include an adhesive. In a step 630, the target object is wrapped with a strengthening material. Alternatively, a precut strengthening material is applied to the target object. A second protective coating is then applied to the target object in a step 640. Application methods include spraying, brushing, rolling and immersion.

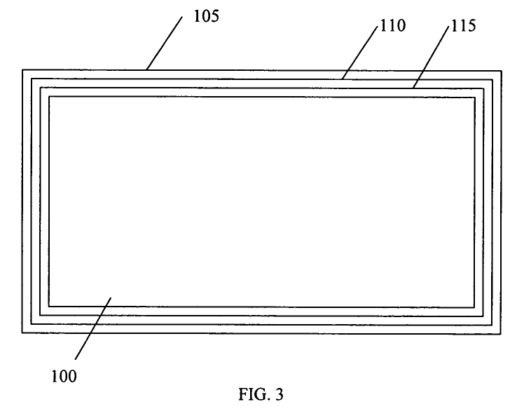

As shown in FIG. 3, a cross tie 100 encapsulated in accordance with the process 600 of the invention includes a first protective coating 115 applied to the cross tie 100, a strengthening material 110 surrounding the first protective coating 115, and a second protective coating 105 therearound.

The process of applying protective coatings to railroad crossties, telephone poles, and telephone pole crossties of the invention provides a cost effective process of additional strength to the target objects as well as encapsulating them to extend their useful life. The process may be used for either new or used target objects of all constructions and materials. Encapsulation of the target object eliminates the need for replacing split or rotten crossties and poles and eliminates the negative environmental impact of chemicals used to treat wooden crossties and poles. The encapsulation further provides for cushioning and dampening layers on the top and bottom of a railroad crosstie so that the vibration dampening problem is mitigated at the lowest cost for both new and used crossties.

The process of applying protective coatings to railroad crossties, telephone poles, and telephone pole crossties of the invention further provides for increased tensile strength of the coated railroad crosstie. Conventionally, the replacement of worn and rotted wooden crossties utilizes machinery that inserts the new crosstie under the rails by picking up the crosstie at one end and sliding it under the rails. The strengthened crosstie of the invention is stiff enough to be handled in this fashion. The strengthened crosstie also prevents flexion of the crosstie when, due to erosion or movement of the stone ballast supporting the crosstie; the crosstie is supported in the middle but not well supported at one or both ends.

It is apparent that the above embodiments may be altered in many ways without departing from the scope of the invention. For example, other coating materials may be used. Further, various aspects of a particular embodiment may contain patentably subject matter without regard to other aspects of the same embodiment. Still further, various aspects of different embodiments can be combined together. Accordingly, the scope of the invention should be determined by the following claims and their legal equivalents.

What is claimed is:

1. A process for applying a protective coating to a target object including railroad crossties, telephone poles, and telephone crossties comprising:
preparing the target object; and
applying a protective coating of a polymer resin to the target object.

2. The process of claim 1, wherein applying the protective coating of the polymer resin to the target object comprises applying polyurea to the target object.

3. The process of claim 2, wherein applying the protective coating of the polymer resin to the target object comprises spraying the polyurea onto the target object.

4. The process of claim 2, wherein applying the protective coating of the polymer resin to the target object comprises brushing the polyurea onto the target object.

5. The process of claim 2, wherein applying the protective coating of the polymer resin to the target object comprises rolling the polyurea onto the target object.

6. The process of claim 2, wherein applying the protective coating of the polymer resin to the target object comprises immersing the target object in a tank containing the polyurea.

7. The process of claim 1, further comprising wrapping the target object with a fabric prior to applying the protective coating of the polymer resin to the target object.

8. The process of claim 7, wherein wrapping the target object with a fabric prior to applying the protective coating of the polymer resin to the target object comprises wrapping the target object with a pre-cut fabric.

9. A process for applying a protective coating to a target object including railroad crossties, telephone poles, and telephone crossties comprising:
preparing the target object;
applying a first protective coating of a polymer resin to the target object;
wrapping the target object with a fabric; and
applying a second protective coating of a polymer resin to the wrapped target object.

10. The process of claim 9, wherein applying a first protective coating of a polymer resin to the target object and applying a second protective coating of a polymer resin to the wrapped target object comprises applying polyurea to the target object.

11. The process of claim 10, wherein applying a first protective coating of a polymer resin to the target object and applying a second protective coating of a polymer resin to the wrapped target object comprises spraying the polyurea onto the target object.

12. The process of claim 10, wherein applying a first protective coating of a polymer resin to the target object and applying a second protective coating of a polymer resin to the wrapped target object comprises brushing the polyurea onto the target object.

13. The process of claim 10, wherein applying a first protective coating of a polymer resin to the target object and applying a second protective coating of a polymer resin to the wrapped target object comprises brushing the polyurea onto the target object.

14. The process of claim 10, wherein applying a first protective coating of a polymer resin to the target object and applying a second protective coating of a polymer resin to the wrapped target object comprises immersing the target object in a tank containing the polyurea.

15. The process of claim 9, wherein applying a first protective coating of a polymer resin to the target object comprises applying an adhesive to the target object.

16. A process for applying a protective coating to a target object including railroad crossties, telephone poles, and telephone crossties comprising:
preparing the target object for application of the protective coating;
applying a first adhesive coating of a polymer resin to the target object;
wrapping the target object with an aramid fiber fabric; and
applying a second protective coating of polyurea to the wrapped target object.
